(19) United States
(12) Patent Application Publication
(10) Pub. No.: US 2010/0007791 A1
(43) Pub. Date: Jan. 14, 2010

(54) TELEVISION DISPLAY EDITOR

(76) Inventors: Mark MEISTER, Potomac, MD (US); James Randall Beckers, Rockville, MD (US)

Correspondence Address: STAAS & HALSEY LLP, SUITE 700, 1201 NEW YORK AVENUE, N.W., WASHINGTON, DC, 20005, US

(21) Appl. No.: 12/169,990

(22) Filed: Jul. 9, 2008

(51) Int. Cl. H04N 5/50; H04N 9/74; H04N 9/12

(52) U.S. Cl. 348/569; 348/578; 348/739; 348/E09.055; 348/E09.012; 348/E05.097

(57) ABSTRACT

A system is disclosed that enhances television viewing by providing users the ability to selectively blank a portion of their screen. Broadcasters today often dedicate some percentage of display “real estate” to push additional content (e.g., scores from other games, regional weather forecasts, etc.) via a virtual “ticker tape”. More often than not, the average viewer will find the ticker tape a distraction if not an annoyance after a short period of time. The embodiments discussed herein allow the viewer a means by which to blank that portion of the screen. The user moves a cursor to designate a portion of the screen to be blanked.

### BACKGROUND

1. Field

The embodiments discussed herein are directed to a system allowing a user to selectively blank portions of a display.

2. Description of the Related Art

Oftentimes it is the case that news, business, or sports programming includes a “ticker tape” feed that runs across the bottom of the screen. The ticker provides a continuous stream of news, weather, scores, quotes, etc., in volume beyond what the news anchor or sports commentator can possibly cover in the same time, or that the entire viewing audience is interested to hear (e.g., the first quarter score of a regional game.) While the additional, up-to-the-minute news may be of interest to some or the hyper-aware viewer, it comes at the expense of being a severe distraction to others. Indeed, some have suggested they feel a slight sensation of vertigo when they stare at the ticker for a few moments and then look away. The room may seem to spin at the speed of the tape. What is needed is a feature by which a TV viewer can selectively blank that portion of his screen in order to hide the (ticker tape) distraction.

### SUMMARY

It is an aspect of the embodiments discussed herein to provide a user the ability to selectively blank portions of a display.

The embodiments discussed herein enhance television viewing by providing users the feature to selectively blank a portion of their screen. It is not unusual for news, business, and sports broadcasters today to dedicate some percentage of display “real estate” to push additional content (e.g., scores from other games, regional weather forecasts, etc.) via a virtual “ticker tape”. More often than not, the average viewer will find the ticker tape a distraction if not an annoyance after a short period of time. The embodiments discussed herein allow the viewer a means by which to blank that portion of the screen.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates a typical business channel broadcast with a stock ticker at the bottom.

FIG. 2 illustrates a typical TV remote control containing audio, video, and menu control buttons.

FIG. 3 is a functional block diagram of a typical digital TV (DTV). It includes a TV signal receive and decode section, an image processing section, display memory section, and a video display section. Also included are a user control section including local and remote control receive interfaces.

FIG. 4 provides an example of an on-screen menu a user might see to control the display blanking.

FIG. 5 is a flowchart describing the user's/viewer's interaction and process by which a portion of the display image may be blanked. The user sends commands from his remote control where it is received and decoded by the user control section. That portion of the image to be blanked is removed by the image processing section where TV frame data is sent to memory, ready for display.

FIGS. 6a-c illustrate a line cursor used by the viewer to define the limits of a region to be blanked (e.g., the ticker at the bottom of FIG. 6a), and the region (ticker) blanked.

FIG. 7 is a flowchart depicting operations within a DTV to blank a portion of the displayed image.

FIGS. 8a-c illustrates that other than rectangular shaped regions could be blanked, and that a viewer could define the limits of the region to blank, or display.

FIGS. 9a-c illustrates an alternative approach to defining the region of the image to blank.

### DETAILED DESCRIPTION OF THE EMBODIMENTS

Digital TV's (DTV) and “set top boxes” of today provide all manner of video processing at the control of the viewer. For example, a viewer can change the video resolution in order to zoom in or stretch an image to fit proportions of his display. Similarly, a viewer can “freeze frame”, split screen, fast forward, and rewind. In fact, typically, audio and video adjustments are made not via mechanical knobs or switches, but through a series of on-screen menus that are superimposed over incoming video at the user's control. In each case, the input programming is buffered, operated upon by the onboard processor, and output for display. The particular “special effect” dictates precisely what processing operations are performed during that middle step.

The ticker blanking feature envisioned here takes advantage of this same sort of video processing capability as described above and inherent in the vast majority of DTV's on the market today. For example, just as a TV viewer uses his remote control to send a signal to the on-board video processor to stretch a movie distributed in “letter-box” format to full-screen, he can, through the embodiments discussed herein, dictate that some portion of his screen (e.g., lines, or group of pixels) be blanked or turned black. Similarly, the remaining image could be stretched proportionately to accommodate the blanked lines.

TV viewers are given feature selection and configuration control through button presses to switches on either a remote control, or integrated into the body of the TV or set-top-box themselves. Generally a menu appears on the screen to allow the user control via additional button-presses.

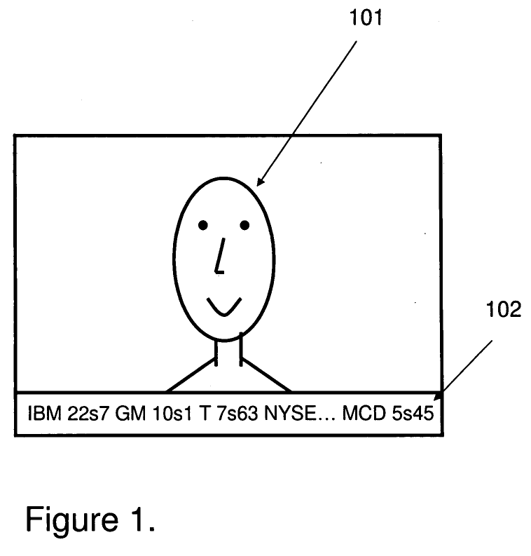

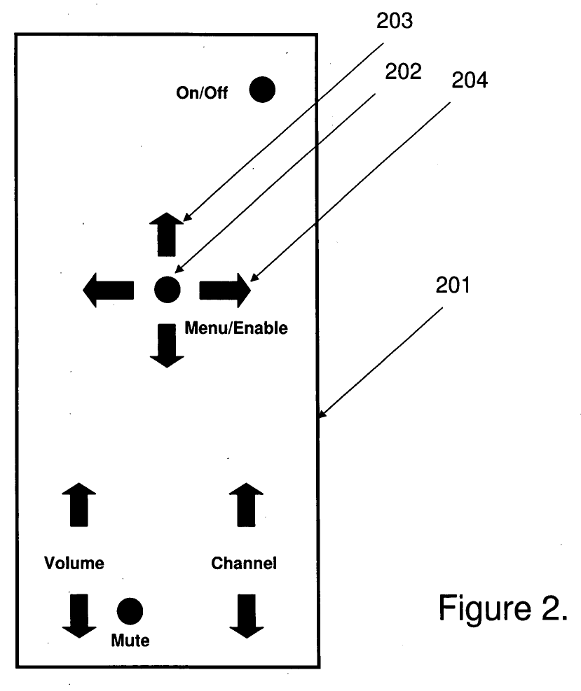

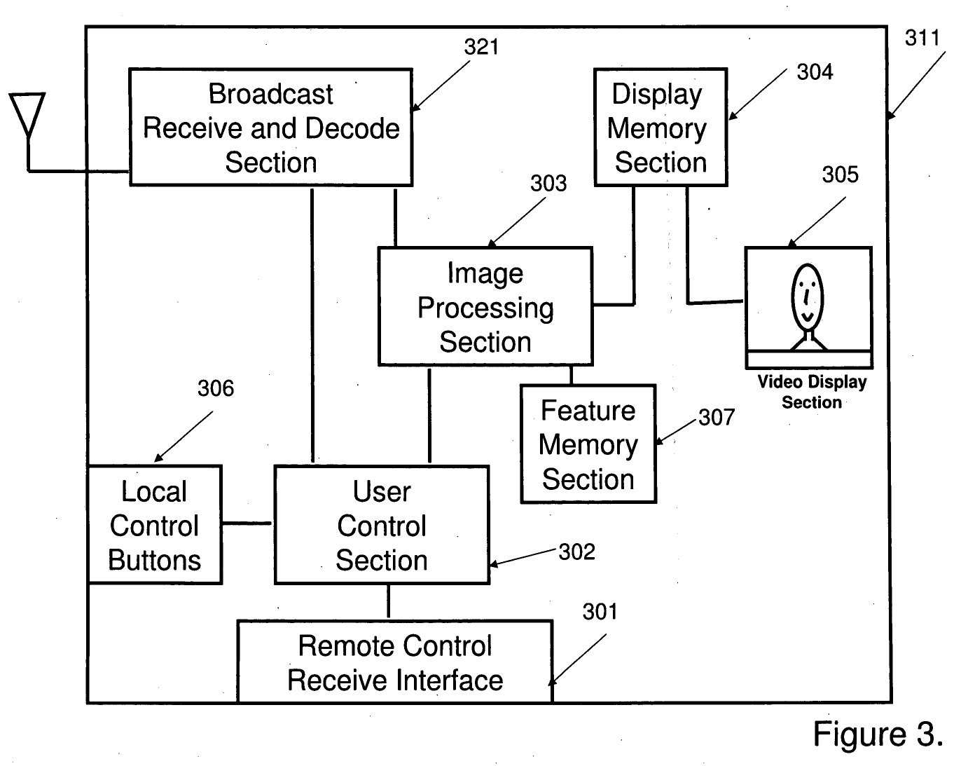

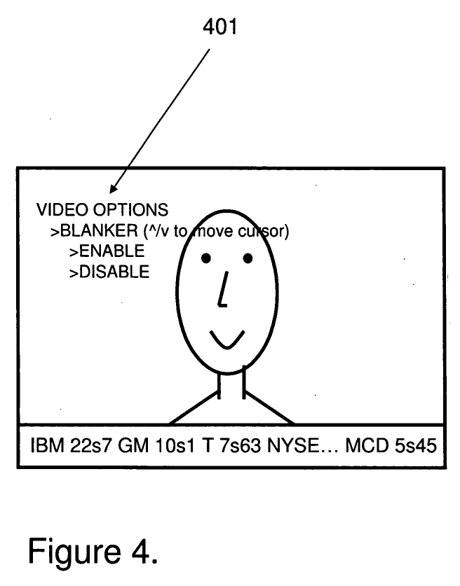

If a TV viewer is watching a broadcast 101 that includes a textual ticker tape feed 102 at the bottom of the display as in FIG. 1, he may wish blank it (the ticker). To do so using his television remote control 201 of FIG. 2, he selects (depresses) the on-screen Menu button 202 on the remote. The control signal decoder/encoder section of the remote translates this command into an IR signal that is received by the DTV's Remote Control Receive Interface 301 of FIG. 3 where it is processed within the User Control Section 302 which results in an on-screen menu being displayed. From there, the user makes additional button presses to navigate through on screen menus until finally selecting the “Blanker” feature submenu FIG. 4 ref. 401. That submenu could instruct the user to use the up/down arrow keys 203 on the remote 201 to define the region to be blanked, and to select “Enable” on the submenu 401 to cause the region 102 to be blanked.

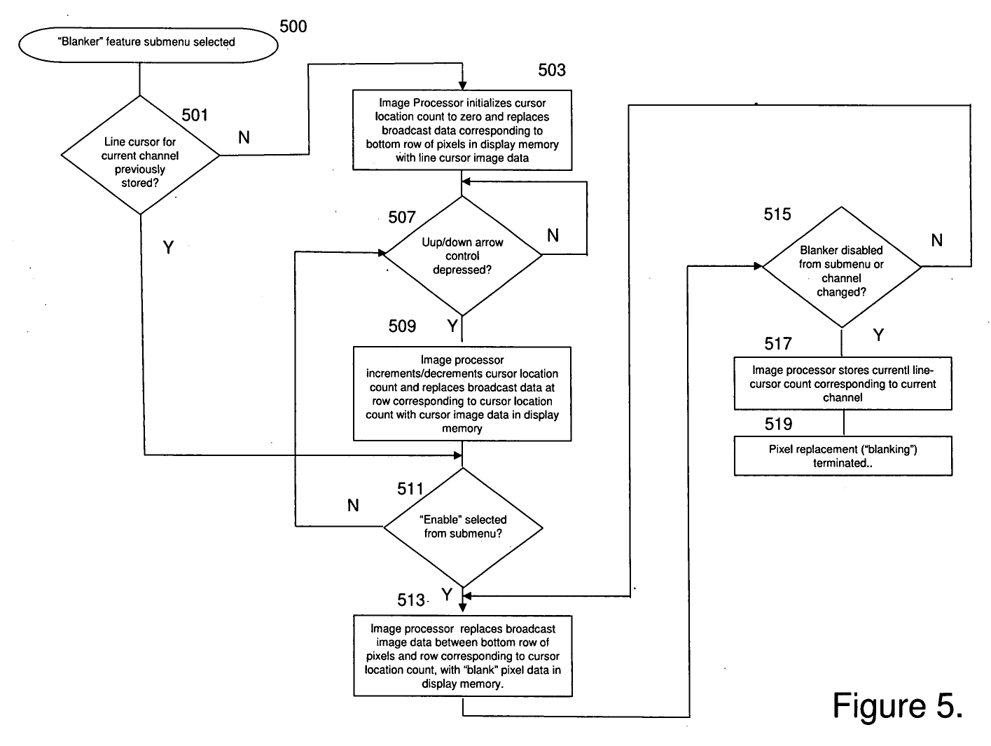

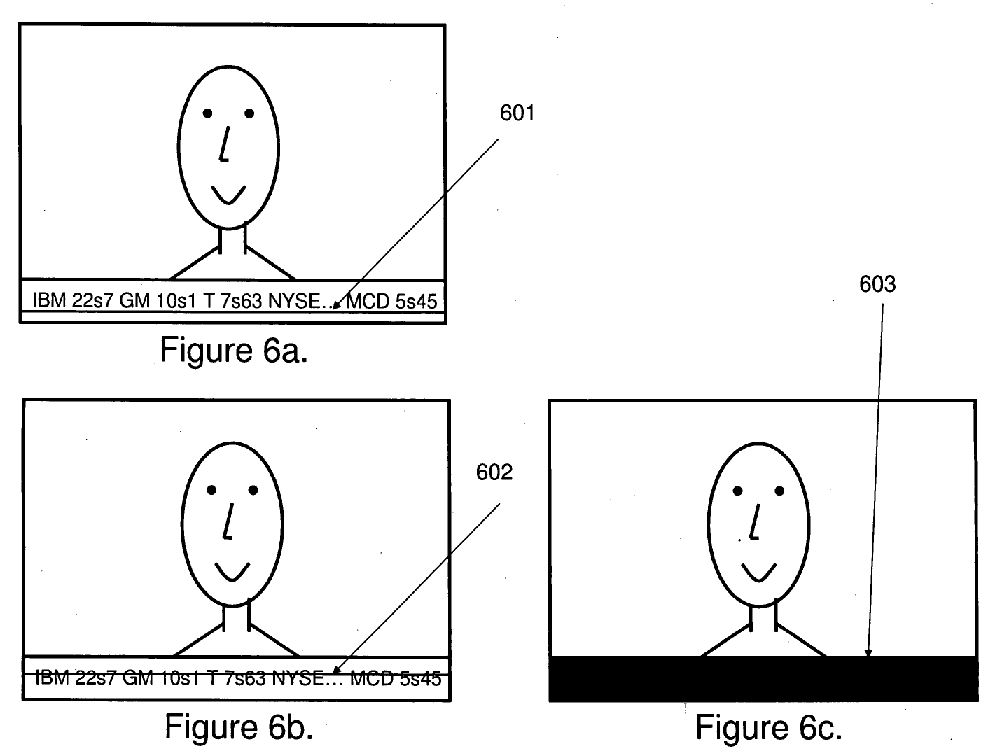

FIG. 5 describes in a flowchart the foregoing process. Once the blanker feature has been selected 500 by pressing the “Enter” key 202 on the remote control 201, the image processor 303 inserts a line cursor, 601 FIG. 6a, into the image data that will appear in the bottom row (or line) of the screen, 305, 503. Next, the user defines the extent of the screen to be blanked. He does so by moving the aforementioned line-cursor 601, 602 up or down on the screen via up/down arrow keys 203 on the remote control 201. Those user inputs are decoded, encoded, transmitted, and received as described earlier. Up or down arrow 203 inputs are translated by the image processor 303 to move the line-cursor 601 up or down by one line per button press, 507, 509. A continuous button press could be made to result in the cursor moving in that direction until released by the user or until the cursor moved the full extent of the screen.

The portion of the screen to be blanked 603 is defined by that region between the line-cursor 601 and the bottom of the screen. That is, those lines between the bottom of the screen and the current position of the line-cursor will be blanked when selected by the user. Once the viewer/user is satisfied with his cursor selection, he causes the selected portion of the display to go dark, effectively blanking the ticker at the bottom of his screen, by selecting Enable 401 on the on-screen Blanker submenu 401. FIG. 6b 603 depicts a “blanked” ticker tape.

Selecting Enable 401 causes the image processing section 303 of the DTV 311 to replace the digital data that maps to that portion of the outgoing data frame to be blanked, with data representing dark pixels (off), 511, 513, 603. From this time forward, the image processing section 303 will make the data replacement for each successive frame update until the user either disables the feature through a similar series of on-screen menu selection steps 401, or until he changes the channel or turns the TV off, 517, 519. To relieve the user of the need to redefine the region to blank each time he returns to a specific channel, the line cursor's position could be stored in feature memory 307, 517, and referenced whenever the user returns to that channel, 501.

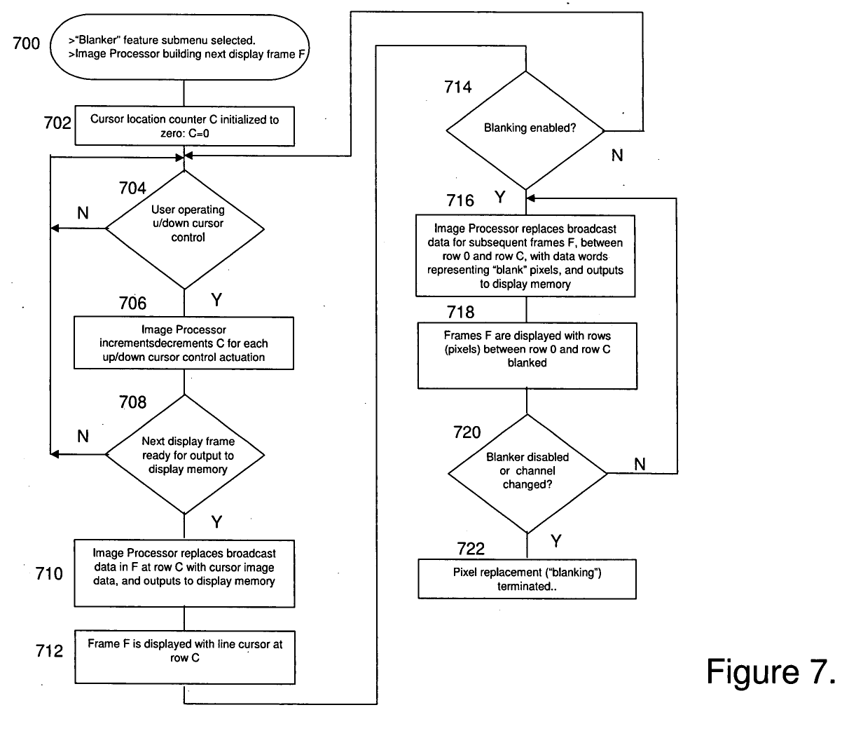

The interaction between the user/viewer, his remote control device 201, and the DTV 311 has been described above. Representative operations within the DTV 311 itself in order to blank the desired region of the display will be discussed in the next level of detail below and is likewise described in the flowchart of FIG. 7. As a basis for discussion throughout, it is assumed that a complete frame of data (one complete update of the image to be displayed) is processed and assembled for output to memory 304 and then display 305, within the image processing section 303. Once ready for display, frame data is written to display memory 304 where each display pixel is represented with unique words of memory with one-to-one correspondence. Data is read into and out of memory 304 via standard memory address counter logic in sequence to be displayed.

Define the bottommost row of the DTV display 305 to be “Line 0”. As the user presses the up or down-arrow keys 203 on his remote 201, a cursor position counter increments or decrements from its current position accordingly. For example, when the feature is first selected, the counter begins at zero, 700, 702. As the user presses the up arrow key, or if he maintains a continuous button press, the counter increments, 704, 706. As image data (digital words corresponding to each individual pixel making up the display) are prepared for each subsequent display update, frame, or scan, 708, the image processor 303 replaces in the outgoing data set 710, data that will cause the pixels in the display line corresponding to the cursor position counter to turn a bright color 712 (i.e., distinctive from the background). The cursor could be made to flash on or off or between two colors, or broadened to include lines on either side of the cursor count should it be hard to view. If the user has driven the cursor position counter up to a count of 50 for example, the image processor 303 will replace the output display data corresponding to line 50 with data that will cause the pixels in the display section 305 that make up line 50 to turn bright yellow (for example.)

Subsequent arrow-button 203 presses are processed as previously discussed and result in directing that the cursor be displayed across subsequent lines on the screen. Once the user is satisfied with the cursor placement and has enabled the blanking feature 714, the image processor section 303 blanks all lines between Line 0 and the line corresponding to the current cursor-position counter count, 716. Although the pixels forming those lines to be blanked can be made not to display that portion of the incoming broadcast image in a variety of ways, one straightforward implementation is simply replace the corresponding image data with the digital code for pixel off. For example, where 24 bits of data might be used to encode the video data, the all-zeros code (i.e., 000 . . . 0) might translate to the pixel off, or dark, condition. In that case, the image processor, when writing the bitmapped frame data to display memory 304, would substitute 0 (zero's) for all pixels that form the lines to be blanked in lieu of the broadcast image for those lines, 718. The substitution would continue until one of the disabling actions discussed previously, is taken (e.g., changing channels), 720, 722.

One alternate approach to blanking the rectangular region at the bottom (or top) of the display would involve the image processing section blanking all pixels between the bottom (or top) row of the display, and the line cursor's current position, while the user moved the cursor (rather than requiring the second step of “enabling” the action as was described above. This would, in effect, appear on the screen as if the user were “wiping” away the ticker for example.

Obviously a ticker or other potentially distracting portion of a video broadcast need not always appear in a full width rectangular region at the bottom of the screen. It could just as easily be located at the top of the screen, or to one side or the other and the embodiments could be modified to blank those regions accordingly. In the same way, the offending region might not be a rectangle at all. Again, the approach described above could be modified to accommodate any arbitrary shape or location within the display at all.

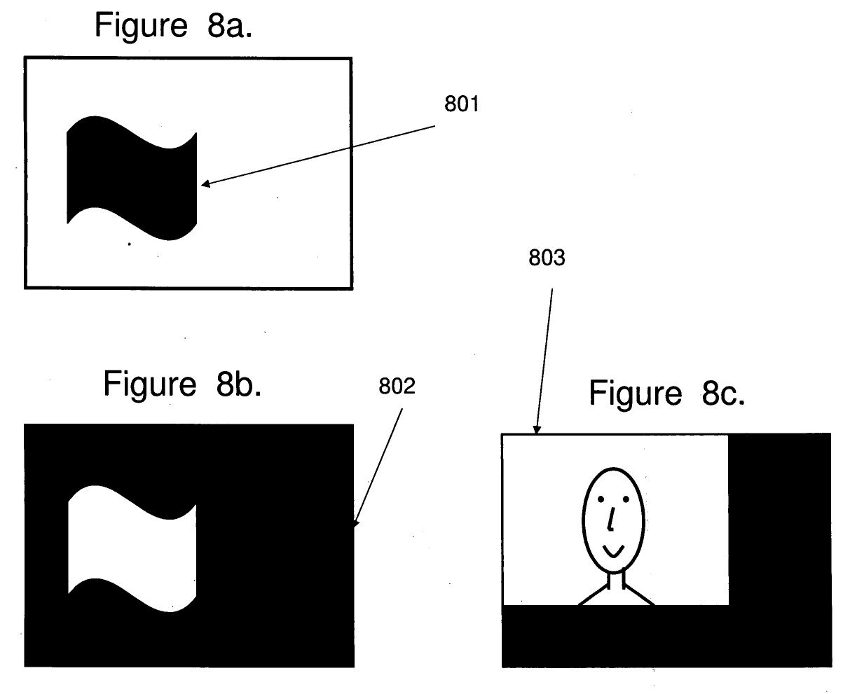

Any region that can be described by cursor placement controlled by a viewer, for example, could be blanked. Instead of using the line-cursor approach as was described above, a viewer might control a point cursor's position on a screen using up/down 203 and left/right arrows 204 on his remote control 201. Much the same way a user of the well known “Etch-A-Sketch” toy can draw “freeform” or arbitrary shapes on his screen, a television viewer could delineate an area to blank. Once the perimeter of the region were defined by cursor movement effectively delineating the first and last pixels on each line to blank, and the uppermost and lowermost lines affected, the image processing section 301 would replace corresponding data words in display frame data with binary codes representing dark pixels as before. A secondary control option, a “toggle switch” could be added to allow the user to blank all pixels inside or outside the defined area. FIGS. 8a and 8b illustrate this inside or outside concept. FIG. 8a, ref. 801 illustrates blanking all pixels within the described region, while 802 illustrates blanking all pixels outside the region. The toggle control could be particularly useful if a viewer wished to blank all but a rectangular region in one corner of the screen, as it is simpler to define the rectangular region the viewer wishes to see in that case than it is to delineate the “hockey stick” shaped region he wishes to blank. See FIG. 8c, for example, where 803 illustrates that portion of the broadcast a viewer wished to see.

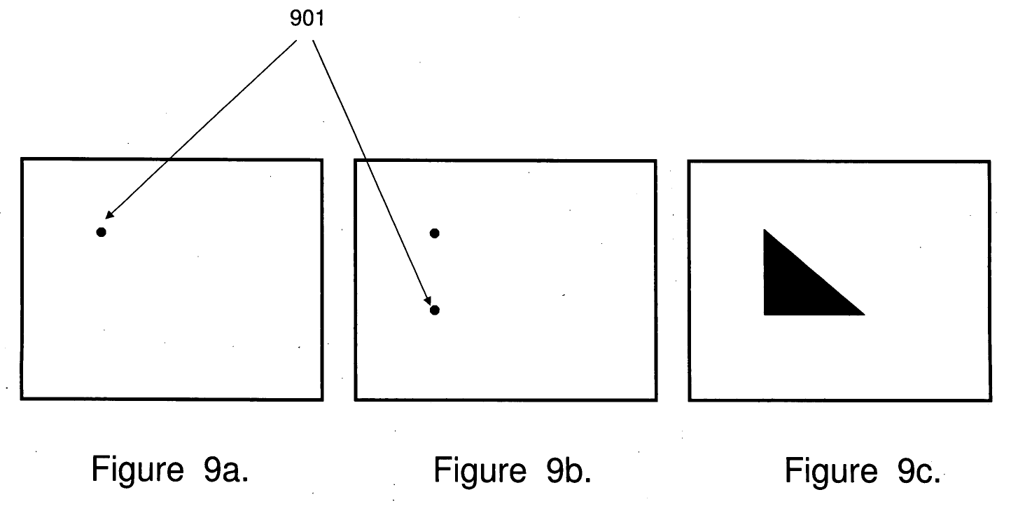

A simpler but more restrictive approach to defining the extent of a region to be blanked might simply provide a viewer the means to select points at vertices (or foci of an ellipse as applicable) of regions to blank. Once three points for a triangular region, four points for a rectangular or trapezoidal region, and so on, were selected, the image processor could blank all pixels falling inside (or outside) the defined area. FIGS. 9a thru 9c illustrate this progression, one vertex 901 selected at a time.

In a way similar to the steps taken to configure the feature via a remote control, it is possible for the user to configure the feature using buttons found on the body of the TV itself. It is also possible that the interaction with and the processing within a television as described above could occur with and within a “set top box”. Finally, it is also clearly possible by simple extension to replace the ticker or offending region with image data other than blanking the region completely. For example, a particular color could be used, or only those parts of the image that are moving could be blanked, i.e., leaving the background intact.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A system, comprising:
a display displaying an image; and
a control system allowing a user to designate a portion of the image for blanking.

2. A system as recited in claim 1, wherein the portion comprises a rectangle along a bottom of the image.

3. A system as recited in claim 1, wherein the portion comprises an L-shaped region along a side an bottom of the image.

4. A system as recited in claim 1, wherein the portion comprises an arbitrary shaped region positioned at an arbitrary position on the image.

5. A system as recited in claim 1, wherein the control system comprises:
a display memory coupled to the display providing the image to the display; and
a processor coupled to the display memory setting the portion of the image to a blank image.

6. A system as recited in claim 5, wherein the blank image is black.

7. A system as recited in claim 5, wherein the control system further comprises a feature memory coupled to the processor storing a record of the portion.

8. A system as recited in claim 7, wherein the record indicates a display row

9. A system as recited in claim 5, wherein the control system further comprises a user interface for designating the portion.

10. A system as recited in claim 9, wherein the user interface comprises a remote control allowing a user to control a position of a cursor in the image.

11. A method, comprising:
allowing a user to designate a portion of an image for blanking; and
blanking the image portion.

12. A method as recited in claim 11, wherein the allowing comprises:
moving a cursor in the image as designated by the user; and
blanking a region of the image as the cursor moves.

13. A method as recited in claim 12, further comprising storing a blanking position as the cursor moves.

14. A method as recited in claim 13, further comprising storing a channel corresponding to the blanking position.

15. A method as recited in claim 8, wherein the cursor is a horizontal line across the image.

16. A method as recited in claim 12, wherein the cursor is a horizontal line intersecting a vertical line extending to an edge of the image.

17. A data structure, comprising:
a received image portion stored in a display memory; and
a blanked image portion stored in the display memory

18. A data structure as recited in claim 17, wherein the blanked portion comprises a rectangle.

19. A data structure as recited in claim 17, wherein the display memory stores pixel values and pixels of the blanked image portion have RGB values of zero.

20. A display, comprising:
a received image portion; and
blanked image portion adjacent the received image portion.

21. A display as recited in claim 20, wherein the blanked portion comprises a rectangle.

22. A display as recited in claim 20, wherein the blanked portion comprises an L-shaped region

23. A display as recited in claim 20, wherein pixel values the blanked image portion have RGB values of zero.

24. A display, comprising:
a channel indicator for a channel being designated for portion blanking a received image portion; and
a blanked image portion adjacent the received image portion designated by a user by moving a cursor so that the blanked portion changes as the cursor is moved, and
wherein the cursor is a horizontal line across the image.
